(19) United States
(12) Patent Application Publication
(10) Pub. No.: US 2016/0176026 A1
(43) Pub. Date: Jun. 23, 2016

(54) MANUAL SCREWDRIVER

(71) Applicants: Fu Tai Hua Industry (Shenzhen) Co., Ltd., Shenzhen (CN); HON HAI PRECISION INDUSTRY CO., LTD., New Taipei (TW)

(72) Inventors: MING-YONG WU, Shenzhen (CN); ZHI-BING JIANG, Shenzhen (CN)

(21) Appl. No.: 14/611,876

(22) Filed: Feb. 2, 2015

(30) Foreign Application Priority Data
Dec. 22, 2014 (CN) 201410801420.X

(51) Int. Cl. B25B 15/06

(52) U.S. Cl. CPC B25B 15/06

(57) ABSTRACT

A manual screwdriver includes a handle, a screwdriver head at a fore end of the handle, a spiral rod connecting with the screwdriver head, and an operating component coiling around the spiral rod. The handle defines a cavity and a slot communicating the cavity to exterior space. The slot is formed along an axial direction of the handle. The spiral rod defines a spiral groove thereon and being rotatably received in the cavity. The operating component includes an engaging block solidly embedded in the slot and a thimble extending through the engaging block. The thimble is driven by an external force to insert into the spiral groove of the spiral rid. The engaging block can slide along the axial direction of the handle via an elastic element to drive the spiral rod and the screwdriver head to synchronously and circularly rotate relative to the handle.

### FIELD

The subject matter herein generally relates to a screwdriver, and particularly to a manual screwdriver.

### BACKGROUND

In the machine field, a screwdriver can be applied to lock fasteners such as screw bolts onto a target object. A traditional screwdriver usually includes a handle and a screwdriver head fixed onto one of two ends of the handle. In operation, the user applies a torque onto the handle to drive the screwdriver head to rotate about an axis of rotation. However, applying the torque manually is labor-consuming and not convenient.

### BRIEF DESCRIPTION OF THE DRAWINGS

Implementations of the present technology will now be described, by way of example only, with reference to the attached figures.

FIG. 1 is an assembled view of a manual screwdriver in accordance with an exemplary embodiment of the present disclosure.

FIG. 2 is an exploded view of the manual screwdriver of FIG. 1.

FIG. 3 is another exploded view of the manual screwdriver of FIG. 1.

FIG. 4 is a cross sectional view of the manual screwdriver of FIG. 1, taken along line IV-IV thereof.

FIG. 5 is another cross sectional view of the manual screwdriver in working state of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “exterior” refers to a region that is beyond the outermost confines of a physical object. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

The present disclosure is described in relation to a screwdriver, and particularly to a labor-saving manual screwdriver.

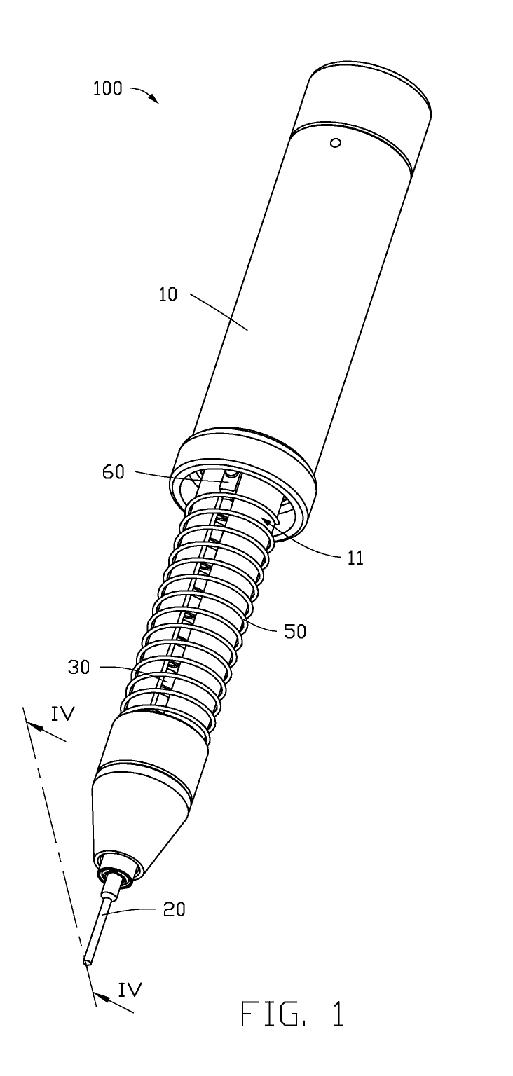

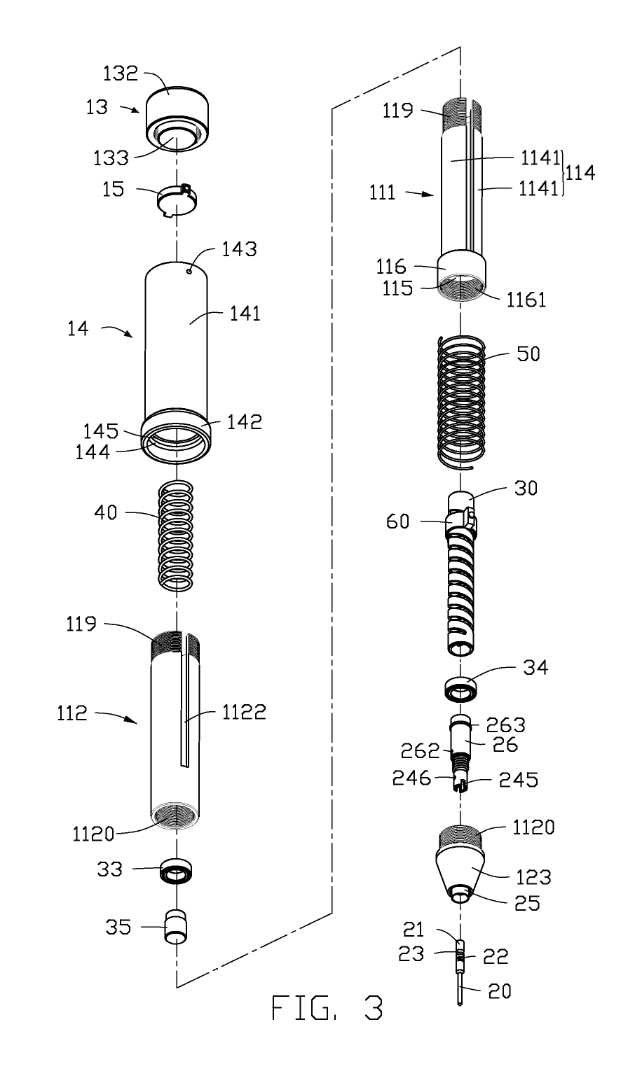

FIGS. 1 to 4 illustrate a manual screwdriver 100 in accordance with an exemplary embodiment of the present disclosure. The manual screwdriver 100 includes a hollow handle 10, a screwdriver head 20 at a free end of the handle 10, a spiral rod 30 and a first elastic element 40 received in the handle 10, a second elastic element 50 and an operating component 60.

Specifically, the handle 10 includes a main body 11, a cap 12 and a rear cover 13 arranged at opposite ends of the main body 11, and a bush 14 coiled around an outer surface of the main body 10.

The main body 11 is hollow and cylindrical. In this embodiment, the main body 11 includes a first main body 111 and a second main body 112 connected thereto. Both the first main body 111 and the second main body 112 are annular. In this embodiment, an outer diameter of the first main body 111 is greater than that of the second main body 112. The first main body 111 and the second main body 112 are cooperatively combined together to form the main body 11. Alternatively, the first main body 111 and the second main body 112 could also be integrally formed together as a single piece.

Specifically. The first main body 111 includes a connecting head 113 adjacent to the cap 12 and a connecting tube 114 connected to the connecting head 113. In this embodiment, the connecting head 113 and the connecting tube 114 are integrally formed as a single piece.

The connecting head 113 includes a top plate 115 and an annular sidewall 116 perpendicularly extending downwardly from a lateral edge of the top plate 115. The top plate 115 is annular, that is the top plate 115 defines a limiting hole 117 at a center thereof. The limiting hole 117 is circular. An inner surface of the side wall 116 is provided with a plurality of inner threads for connecting with the cap 12.

The connecting tube 114 is tubular. An outer diameter of a horizontal projection of the connecting tube 114 on the top plate 115 is smaller than an outer diameter of the top plate 115. An inner diameter of the horizontal projection of the connecting tube 114 on the top plate 115 is equal to a diameter of the limiting hole 117.

That is an inner surface of the connecting tube 114 is coplanar with a vertical surface of the top plate 115 located at the limiting hole 117. In this embodiment, the connecting tube 114 includes two positioning sheets 1141 opposite to each other. Each of the positioning sheets 1141 is arc shaped. The two positioning sheets 1141 are spaced from each other and cooperatively define two first grooves 1142 therebetween. That is a bottom end of each first groove 1142 extends to the connecting head 113. A length of each first groove 1142 is equal to that of the connecting tube 114. The two first grooves 1142 are symmetrically arranged relative to an axial direction of the first main body 111. Each of the first grooves 1142 is linear and extends along the axial direction of the first main body 111, it namely that each first groove 1142 is a slot. The two positioning sheets 1141 cooperatively form a first cavity 118 for receiving the spiral rod 30.

A top end of each positioning sheet 1141 away from the connecting head 113 is provided with threads at the out surface thereof. That is a plurality if outer threads 119 are formed at the outer surface of the top end of the connecting tube 114 away from the connecting head 113. The top end of each positioning sheet 1141 away from the connecting head 113 is also provided with a step 1131 at an inner surface thereof. Alternatively, in other embodiment, the bottom ends of the first grooves 1142 could be spaced from the top plate 115, that is the two first grooves 1142 only be defined at the top end of the connecting tube 114 without extending to the top plate 115. A length of the each groove 1142 is less than that of the connecting portion 114.

The second main body 112 is tubular. An inner diameter of the second main body 112 is equal to the outer diameter of the connecting tube 114. That is an outer diameter of the second main body 112 is greater than that of the connecting tube 114. In this embodiment, the outer diameter of the second main body 112 is equal to that of the connecting head 113.

A bottom end of the second main body 112 near to the first main body 111 is provided with a plurality of inner threads 1120 corresponding to the outer threads 119 on the connecting tube 114 for screwing the first main body 111 and the second main body 112.

The second main body 112 further includes a positioning block 1121 at the inner surface thereof adjacent to the inner threads 1120. The positioning block 1121 is annular and arranged above the inner threads 1120. The positioning block 1121 defines another limiting hole 117 opposite to the limiting hole on the connecting head 113. The second main body 112 defines two second grooves 1122 symmetrically arranged above the positioning block 1121. The second grooves 1122 and the inner threads 1120 are located two opposite sides of the positioning block 1121. The second grooves 122 are linear and extending along an axial direction of the second main body 112. A length of the each second groove 1122 is less than that of the second main body 112. Preferably, the second grooves 1122 correspond to the first grooves 1141 on the first main body 111, that is the second grooves 1122 and the first grooves 1142 are respectively and correspondingly collinear with each other. Alternatively, the second grooves 1122 and the first grooves 1142 could be staggered with each other.

A top end of the second main body 112 away from the first main body 111 is provided with another plurality of outer threads 119 for connecting the second main body 112 and the rear cover 13.

The cap 12 defines a through hole 121 at a center thereof. The through hole 121 extends through two opposite ends of the cap 12 along an axial direction of the cap 12. The cap 12 includes a connecting portion 122 and a cap tine 123 connected with the connection portion 122. The connecting portion 122 is annular. An outer surface pf the connecting portion 122 is provided with a plurality of outer threads 1220 corresponding to the inner threads 1161 of the connecting head 113. The connecting portion 122 further includes a step 1222 at an inner surface thereof. The cap tine 123 is a frustum of cone. An outer diameter of the cap tine 123 gradually decreases as it extends downward away from the first main body 111.

The rear cover 13 includes a rear plate 131, a rear sidewall 132 and a shaft portion 133 connected with the rear plate 131. The rear plate 131 is circular. The rear sidewall 132 is annular. The rear sidewall 132 extends toward the second main body 112 from a lateral periphery of the rear plate 131. The shaft portion 133 extends toward the second main body 112 from a center of the rear plate 131. A height of the shaft portion 133 is greater than that of the rear sidewall 132, that is the shaft portion 133 extends beyond an end surface of the rear sidewall 132 near to the second main body 112. The rear sidewall 132 surrounds the shaft portion 133. The rear sidewall 132 is spaced from the shaft portion 133. The rear sidewall 132 defines inner threads 134 on an inner surface thereof corresponding to the outer threads 119 of the second main body 112.

The bush 14 is sleeved onto an outer wall of the second main body 112 for sliding on the second main body 112. The bush 14 includes a handle tube 142 connected to the handle tube 141. The handle tube 141 defines two insertion holes 143 at a top end thereof near to the rear cover 13. The operating portion 142 is annular. A inner diameter of the operating portion 142 is greater than that of the handle tube 141. The operating portion 142 includes an inclined surface 144 at a top end near to the handle tube 141. The operating portion 142 and the handle tube 141 cooperatively form a positioning step 145 therebetween. The inclined surface 144 guides the operating component 60 into the positioning step 145. Preferably, in this embodiment, a smaller angle defined by the inclined surface 144 and a horizontal surface is 60 degrees. An inner diameter of the positioning step 145 is greater than that of the handle tube 141.

The bush 14 is connected to the second main body 112 via a pressing plate 15. The pressing plate 15 and the second main body 112 cooperatively form a second cavity 150. Specifically, the pressing plate 150 includes a circular main plate 151, two flanges 152 arranged two opposite sides of the main plate 151, and a connecting hole 153 extending through the main plate 151 and the two flanges 152. The two flanges 152 is symmetrically arranged relative to an axial direction of the main plate 151. A width of each flange 152 is substantially equal to a width of the second groove 1122, thus the pressing plate 15 could fittingly slide in the second groove 1122. The bush 14 and the second main body 112 are connected together via an external fixing component (not shown) penetrating the connecting hole 153 and the two insertion holes 143. Alternatively, the pressing plate 15 could only include the main plate 151 without the flanges 152.

The screwdriver head 20 is rod-shaped. The screwdriver head 20 has an end portion 21 near to the handle 10. The screwdriver head 20 has two protruded ears 22 symmetrically extending outward from a middle portion thereof. The screwdriver head 20 defines two recessed neck portions 23 between the protruded ears 22 and an end 21 of the screwdriver head 20. Each of the two recessed neck portions 23 has a decreased diameter than that of the end portion 21 of the screwdriver head 20.

The screwdriver head 20 and the handle 10 are connected together via a first pin 24, a snap ring 25, a second pin 26 and a third elastic element 27.

Specifically, the first connecting pin 24 includes an elongated shaft pole 241 and an enlarged head portion 242 connected to the shaft pole 241. The enlarger head portion 242 has an increased diameter than that of the shaft pole 241. A step 243 is defined between the shaft pole 241 and the enlarged head portion 242. A top end of the shaft pole 241 away from the enlarged head portion 242 defines a through hole 2411. The enlarged head portion 242 of the first connecting pin 24 defines a recess 244 for accommodating the end 21 of the screwdriver head 20. The recess 244 defines two slits 245 for respectively receiving the protruded ears 22, so as to prevent rotation movement between the screwdriver head 20 and the first connecting pin 21 when assembled. The first connecting pin 21 also defines two connecting holes 246 corresponding to the two recessed neck portions 23 of the screwdriver head 20.

The snap ring 25 defines an annular baffle 251 extending radially inward from one end periphery thereof. An inner diameter of the baffle 251 is substantially equal to an outer diameter of the shaft pole 241, but less than an outer diameter of the enlarged head portion 242 of the first connecting pin 21.

The second connecting pin 26 is a column, a bottom end of the screwdriver head 20 defines a recess 261 for receiving a top end of the shaft pole 24l away from the enlarged head portion 242. The second connecting pin 26 defines a pair of through holes 262 corresponding to the through hole 2411 of the shaft pole 241 for connecting the first connecting pin 24 and the second connecting pin 26 with other fixing component (not shown). A latching ring 263 is sleeved onto an outer wall of the second connecting pin 26 near to the handle 10 for connecting the second connecting pin 26 and the cap 12.

The third elastic element 27 is sandwiched between the snap ring 25 and the second connecting pin 26. The third elastic element 27 provides an elasticity to prevent the snap ring 25 from sliding to the second connecting pin 26.

The spiral rod 30 is a hollow cylinder. An outer diameter of the spiral rod 40 is smaller than an inner diameter of the first main body 111. A length of the spiral rod 30 is less than a length of the first main body 111. The spiral rod 30 is made of rigid materials such as rolled steel or other rigid metals for reinforcing the strength thereof

The spiral rod 30 defines a spiral groove 61 at an outer surface thereof. The spiral rod 30 also defines a third cavity 32 therein. In this embodiment, the spiral groove 31 communicates with the third cavity 32, that is a depth of the spiral groove 31 is less than a thickness of the spiral rod 30. The spiral groove 31 surrounds the third cavity 32 and spirally extends from one of two ends of the spiral rod 30 towards the other end of the spiral rod 30. Namely, the spiral groove 31 is arranged to be inclined to an axis of rotation of the spiral rod 30. In detail, an intersection angle between the spiral groove 31 and the axis of rotation of the spiral rod 30 is an acute angle. Alternatively, the spiral groove 31 also could be merely defined at the outer surface of the spiral rod 30 and spaced from the third cavity 32, it is namely that a depth of the spiral groove 31 is less than a thickness of the spiral rod 30.

A first bearing 33 and a second bearing 34 are further arranged at opposite ends of the spiral rod 30. The first bearing 33 is arranged on the step portion 1131 of the top end of the connecting tube 114 and sandwiched between the positioning block 1121 and the step portion 1131. The first bearing 33 is connected with the spiral rod 30 via the third connecting pin 35. The third connecting pin 35 is a column. Specifically, the first bearing 33 and a top end of the spiral rod 30 adjacent to the positioning block 1121 are respectively sleeved and interferingly fixed onto two opposite ends of the third connecting pin 35.

The second bearing 34 is arranged between the step 1222 of the cap 12 and the latching ring 263 of the second connecting pin 26. Specifically, the second bearing 34 and a bottom end of the spiral rod 30 adjacent to the cap 12 are sleeved onto and interferingly fixed onto two opposite ends of the second connecting pin 35. It is namely that a top end of the second connecting pin 26 and a bottom end of the third connecting pin 35 are embedded into the third cavity 32 of the spiral rod 30. The first bearing 33 and the second bearing 34 can enable the spiral rod 30 and the first main body 11 to be coaxially aligned to each other.

The first elastic element 40 is received in the second cavity 112. Specifically, the first elastic element 40 is sandwiched between the positioning block 1121 and the pressing plate 15. An outer diameter of the first elastic element 40 is greater than that of the spiral rod 30.

The second elastic element 50 is sleeved onto the outer surface of the first main body 111. Specifically, the second elastic element 50 is sleeved onto the outer surface of the connecting tube 114. A bottom end of the second elastic element 50 resists the top surface of the connecting head 113. An outer diameter of the second elastic element 50 is greater than that of the first elastic element and smaller than the inner diameter of the bush 14.

The operating component 60 is sleeved onto the outer surface of the spiral rod 30 and adjacent to the second main body 112. The operating component 60 can slide relative to the spiral rod 30. Specifically, the operating component 60 includes a engaging ring 61, two engaging blocks 62 symmetrically arranged at two opposite sides of the engaging ring 61, two thimbles 63 each penetrates corresponding engaging block 62 and the engaging ring 61, and a spring 64. The engaging ring 61 is coiled around the spiral rod 30. The engaging block 62 is embedded in the first groove 1142 of the first main body 111 and can slide in the first groove 1142 along the axial direction of the main body 111. The engaging blocks 62 prevent the operating component 60 from rotating along a radial direction relative to the first main body 111. A length of each of the thimbles 63 is greater than a width of the engaging block 62 along the radial direction of the spiral rod 30. A free end of each of the thimbles 63 extends beyond an lateral surface of the engaging block 62 to resist the inner surface of the operating portion 142 in natural state. When the thimbles 63 are compressed to press the spring, each of the thimbles 63 can horizontally move relative to the engaging ring 61 and the corresponding engaging block 62. A top end of the second elastic element 50 rightly resists to bottom surfaces of the engaging blocks 62 in natural state. It is namely that the second elastic element 50 is sandwiched between the operating component 60 and the connecting head 113 of the first main body 111. In this embodiment, the first elastic element 40, the second elastic element 50 and the third elastic element 27 are spiral spring.

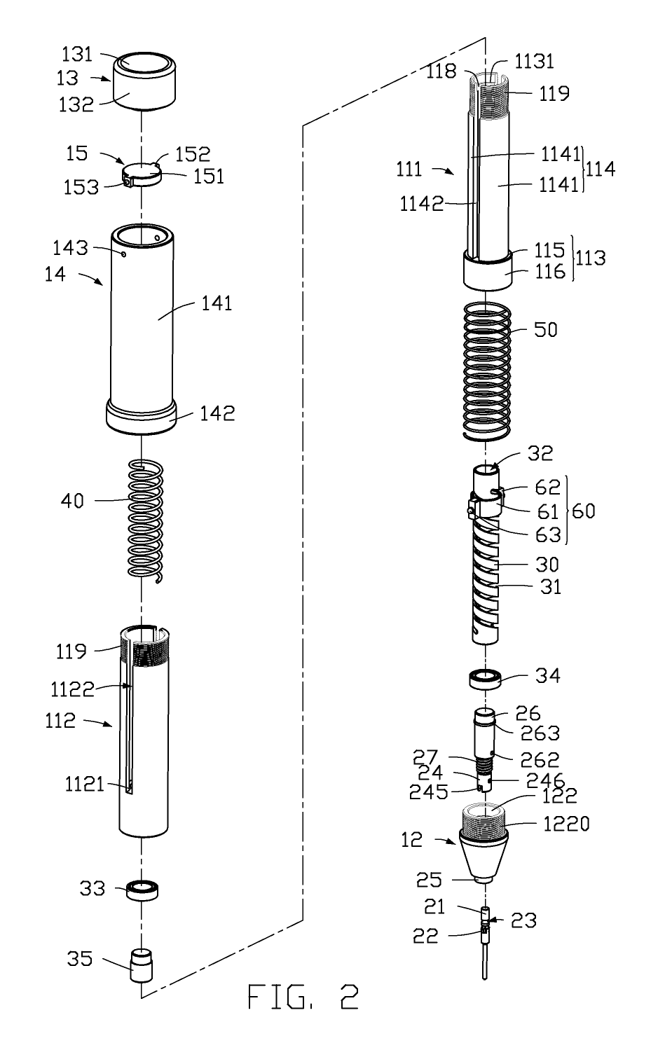

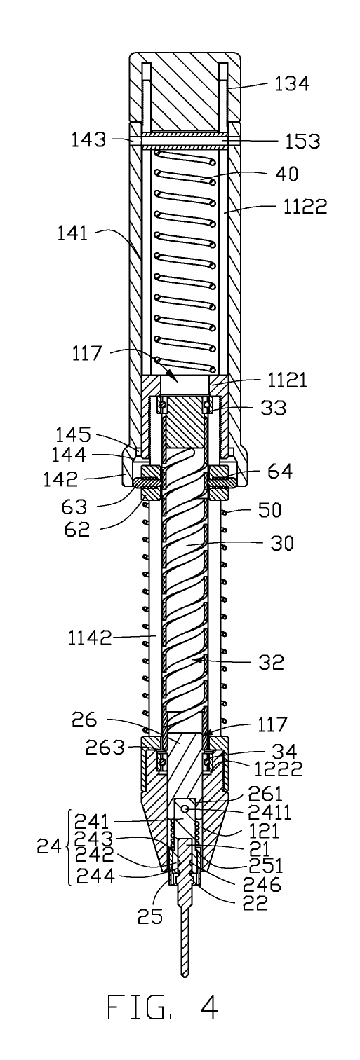

FIG. 4 illustrates a cross sectional view of the manual screwdriver 100. When assembled, the end portion 21 of the screwdriver head 20 is inserted into the recess 244 of the first connecting pin 24 with two protruded ears 22 sliding into the two slits 245 of the recess 244 (see FIG. 2). One of two recessed neck portions 23 is exposed through the two connecting holes 246. Two fasteners (not shown) are partially embedded into the two connecting holes 246, respectively. The snap ring 25 is sleeved onto the shaft pole 241 of the first connecting pin 24 and slides toward the head portion 242, until the baffle 251 is retained by the step 243 of the first connecting pin 24, and the two fasteners are engaged between the recessed neck portion 23 of the screwdriver head 20 and an inner wall of the snap ring 25.

The third elastic element 27 is coupled to the shaft pole 241 of the first connecting pin 24. The first connecting pin 24 is releasably connected to the second connecting pin 26 via screw bolt (not shown) penetrating the through hole 2411 on the shaft pole 241 and the through holes 262 on the second connecting pin 26. The third elastic element 27 is located between the snap ring 25 and the second connecting pin 26. The third elastic element 27 provides an elastic elasticity to prevent the snap ring 25 form moving to the second connecting pin 26. Accordingly, the screwdriver head 20 is releasably connected to the second connecting pin 26.

The second bearing 34 is sleeved onto the second connecting pin 26. The second bearing 34 is arranged on the step 1222 of the cap 12. A top end of the second bearing 34 resists the bottom surface of the latching ring 263, and the second bearing 34 is sandwiched between the latching ring 263 and the step 1222. Accordingly, the screwdriver head 20 is connected to the cap 12.

The first main body 11 is screwed onto the cap 12. The connecting portion 122 is connected to the connecting head 113 by screwing the outer threads 1220 and the inner threads 1161. The operating component 60 is coupled to the top end of the spiral rod 30, and the spiral rod 30 is inserted into the first cavity 118 along the first groove 1142. The bottom end of the spiral rod 30 is coupled to the top end of the second connecting pin 26 by resisting a top surface of the latching ring 263. Then spiral rod 30 and the second bearing 34 are respectively located at two opposite sides of the latching ring 263. The second elastic element 50 is sleeved onto the first main body 111. The first bearing 33 is arranged on the step portion 1131 of the first main body 111. The first bearing 33 is connected with the spiral rod 30 via the third connecting pin 35. The first bearing 33 and the top end of the spiral rod 30 are respectively sleeved onto two opposite ends of the third connecting pin 35 and interferingly fixed.

The first main body 111 and the second main body 112 are connected with each other by screwing the outer threads 119 and the inner threads 1120. The first elastic element 40 is received in the second main body 112. The pressing plate 15 is arranged on the first elastic element 40. The bush 14 is connected with the second main body 112 with a fixing component (not shown) passing through the connecting hole 153 and the insertion holes 143. Two opposite ends of the first elastic element 40 respectively and rightly resist the pressing plate 15 and the positioning block 1121 without deformation. Finally, the second main body 112 is connected with the rear cover 13 by screwing the outer threads 119 and the inner threads 134. The thimbles 63 of the operating component 60 are wrapped by the operating portion 142 of the bush 14 by resisting the inner surface of the operating portion 142.

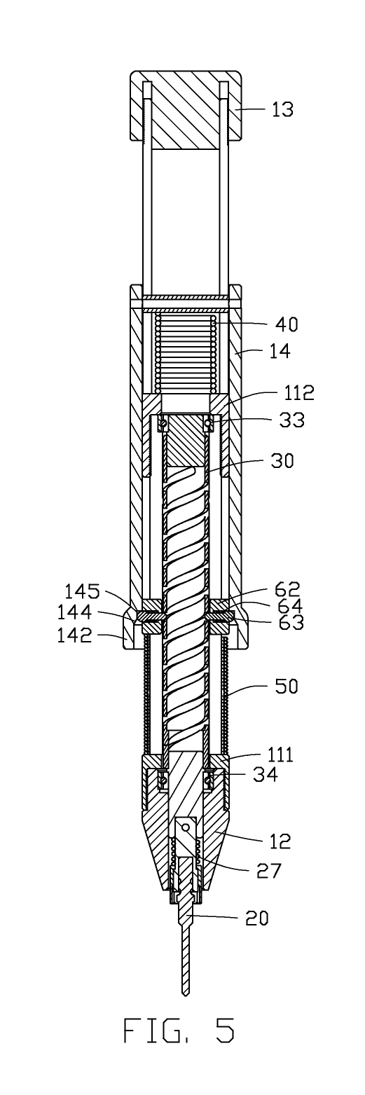

FIG. 5 illustrates a cross sectional view of the manual screwdriver 1 in working state. In operation, the screwdriver head 20 engages the fastener such as screw bolt, and the user pushes the bush 14 to move toward the screwdriver head 20 along the handle 10. The first elastic element 40 and the second elastic element 50 are compressed, and the free end of each thimble 63 slides into the positioning step 145 along the inclined surface 144 of the operating portion 142. Another end of each thimble 63 opposite to the free end of is pressed to insert the spiral groove 31 of the spiral rod 30 along the radial direction of the spiral rod 30. The spring 64 is compressed to make the operating component 60 and spiral rod 30 connected along the axial direction of the spiral rod 30. When the bush 14 is further moved toward to the screwdriver head 20, since the operating component 60 could only slide in the first groove 1142 along the axial direction of the first main body 111. The spiral rod 30 connecting with the firs bearing 33 and the second bearing 34 are driven to rotate in a clockwise direction about the axis of rotation of the spiral rod 30 relative to the handle 10, thereby enabling the screwdriver head 20 to synchronously and circularly rotate with the spiral rod 30.

A maximum elasticity of the second elastic element 50 is designed to be not enough to drive the spiral rod 30 to counter-rotate. When the first elastic element 40 is compressed to its maximum, the fastener such as screw bolt hasn't be tightly screwed. Thereafter the force applied onto the bush 14 is withdrawn, the bush 14 is pushed upward by the first elastic element 40 to make the thimbles 63 slide out of the positioning step 145 via the inclined surface 144, the spring 64 resiles to separate the thimbles 63 from the spiral rod 30 along the axial direction of the spiral rod 30, finally the operating component 60 is driven to move upward to the top end of the spiral rod 30 by the second elastic element 50. The user can repeat the above operation for tightly screwing the fastener such as screw bolt to complete a work cycle.

In the present embodiment, by taking advantages of screw principle, a linear movement of the operating component 60 in the first groove 1142 is converted into a rotation movement of the spiral rod 30, thereby enabling the screwdriver head 20 to synchronously and circularly rotate with the spiral rod 30. It is convenient and labor-saving for the user to operate the manual screwdriver 100. The thimbles 63 firstly slide out of the positioning step 145 and are axially separated from the spiral rod 30 once the force applied onto the bush 14 is withdrawn, so as to prevent the spiral rod 30 from rotating counter-clockwise, and thereby to increase a screwing efficiency of the faster such as screw bolt.

In addition, different components of the manual screwdriver 100 are releasably combined together, so the manual screwdriver 100 can be assembled or disassembled with ease and efficiency. For example, when the screwdriver head 20 needs to be replaced, the user can push the snap ring 25 to move toward the first connecting pin 24 until the fasteners (not shown) is completely exposed out from the snap ring 25. Finally, the user can easily take out the fastener (not shown) and disengage the screwdriver head 20 from the handle 10.

In the present embodiment, the first main body 111, the second main body 112, the cap 12 and the rear cover 13 are separately molded and then releasably connected and assembled to increase an agility of the manual screwdriver 100.

The embodiments shown and described above are only examples. Many details are often found in the art such as the other features of manual screwdrivers. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A manual screwdriver comprising:
a handle defining a cavity and a slot communicating the cavity to an exterior space, the slot being formed along an axial direction of the handle;
a screwdriver head provided at a fore end of the handle;
a spiral rod connecting with the screwdriver head, the spiral rod defining a spiral groove thereon and being rotatably received in the cavity; and
an operating component coiling around the spiral rod, the operating component comprising an engaging block solidly embedded in the slot and a thimble extending through the engaging block;
the thimble being driven by an external force to insert the thimble into the spiral groove of the spiral rod, the engaging block being configured to slide along the axial direction of the handle via an elastic element to drive the spiral rod and the screwdriver head to synchronously and circularly rotate relative to the handle.

2. The manual screwdriver of claim 1, wherein the spiral rod is a hollow cylinder, the spiral rod defining another cavity therein, the spiral groove communicating with the cavity of the spiral rod, the elastic element being sleeved onto an outer surface of the handle, the spiral groove extending from one of two ends of the spiral rod toward the other end of the spiral rod, the spiral groove being arranged to be inclined to an axis of rotation of the spiral rod.

3. The manual screwdriver of claim 1, wherein two opposite ends of the spiral rod each is provided with a bearing, the spiral rod and the two bearings being interferingly fixed via two connecting pins, the spiral rod being adapted to circularly rotate relative to the handle via the two bearings.

4. The manual screwdriver of claim 1, further comprising a rear cover arranged at a rear end of the handle, the rear cover and the handle being releasably connected.

5. The manual screwdriver of claim 4, further comprising an operating portion that includes an inclined surface provided at a rear end near to a handle tube, the inclined surface guiding the operating component into a positioning step.

6. The manual screwdriver of claim 5, wherein a smaller angle defined by the inclined surface and a radial surface is 60 degrees.

7. The manual screwdriver of claim 1, wherein the handle comprises a main body and a bush coiling around an outer surface of the main body, the main body defining the cavity for receiving the spiral rod, the bush comprising a handle tube and an operating portion, an inner diameter of the operating portion being greater than that of the handle tube, a free end of the thimble resisting an inner surface of the operating portion, the operating portion and the handle tube cooperatively forming a positioning step therebetween, the thimble being driven by the external force to slide into the positioning step , the thimble being inserted into the spiral groove of the spiral rod via pushing the bush to move toward the screwdriver head.

8. The manual screwdriver of claim 7, wherein the main body further comprises a first main body and a second main body connected with the first main body, the spiral rod being received in the first main body, a second elastic element being received in the second main body, the second main body defining a groove along an axial direction of the handle, the second elastic element driving the thimble to slide out of the spiral groove, the first main body comprising a connecting tube and a connecting head arranged to the fore end of the connecting tube, an outer diameter of the connecting head being greater than that of the connecting tube, the slot being defined on the connecting tube, the elastic element being sleeved onto an outer surface of the connecting tube and sandwiched between the engaging block and the connecting head.

9. The manual screwdriver of claim 8, wherein the first main body and the second main body are releasably connected by defining matched threads at ends of the first main body and the second main body near to each other, a positioning block is formed at an inner surface of the second main body adjacent to the threads of the second main body, the second elastic element is arranged at one end of the positioning block away from the screwdriver head.

10. The manual screwdriver of claim 8, wherein a rear end of the first main body defines a step portion at an inner surface near to the second main body.

11. The manual screwdriver of claim 8, wherein the handle comprises a cap arranged at the fore end of the main body, the connecting head of the first main body being connected with the cap, the screwdriver head and the cap being interferingly fixed together.

12. The manual screwdriver of claim 11, wherein the connecting head of the first main body comprises a top plate and an annular sidewall perpendicularly extending forward from a lateral periphery of the top plate, the annular sidewall defining inner threads, the cap comprising a connecting portion and a cap tine connected therewith, the connecting portion of the cap defining outer threads corresponding to the inner threads of the connecting head of the first main body, the connecting portion and the connecting head being coupled with each other, the connecting portion defining a step in an inner surface thereof, the cap tine being a frustum of cone, an outer diameter of the cap tine gradually decreasing while extending forward away from the first main body.

13. The manual screwdriver of claim 12, wherein the bush is connected to the second main body via a pressing plate received in the second main body, the second elastic element being arranged between the pressing plate and the positioning block.

14. The manual screwdriver of claim 13, wherein the pressing plate comprises a circular main plate, and a connecting hole extending through the main plate, a rear end of the bush defining two insertion holes corresponding to the connecting hole of the pressing plate, the bush and the second main body being connected together via an external fixing component that penetrates the connecting hole and the two insertion holes.

15. The manual screwdriver of claim 14, wherein the pressing plate further comprises two flanges corresponding to the groove of the second main body, the two flanges being fittingly slid in the groove of the second main body, the connecting hole passing through the two flanges.
